(19) United States
(12) Patent Application Publication
(10) Pub. No.: US 2026/0006327 A1
(43) Pub. Date: Jan. 1, 2026

(54) CAMERA SYSTEM, CAMERA, METHOD FOR CONTROLLING SAME, AND STORAGE MEDIUM

(71) Applicant: CANON KABUSHIKI KAISHA, Tokyo (JP)

(72) Inventor: YUTA MASUDA, Kanagawa (JP)

(21) Appl. No.: 19/246,397

(22) Filed: Jun. 23, 2025

(30) Foreign Application Priority Data
Jun. 26, 2024 (JP) 2024-103358

(51) Int. Cl. H04N 23/67; H04N 23/63

(52) U.S. Cl. CPC H04N 23/675; H04N 23/631

(57) ABSTRACT

A system including a lens apparatus including a focus lens, a first operation unit, and a second operation unit, and a camera apparatus including a third operation unit. The system includes a first control unit configured to, while a focus lens is moving due to execution of a first function based on operation on the first operation unit, perform control so as not to execute adjustment processing based on operation on the second operation unit, and a second control unit configured to, while the focus lens is moving due to execution of the second function based on operation on the third operation unit, perform control to switch execution and non-execution of the adjustment processing based on the operation on the second operation unit, depending on a predetermined setting of the camera apparatus.

### BACKGROUND

### Field of the Technology

The aspect of the embodiments relates to a camera system, a camera, a method for controlling the same, and a storage medium.

### Description of the Related Art

Some imaging lenses have a focus preset recall function of storing a focus position in advance, reading the stored focus position, and moving their focus lens to the focus position to capture images in focus without missing decisive moments.

Japanese Patent Application Laid-Open No. 2023-141434 discusses an interchangeable lens including a focus lens operation ring, a lens preset button, a lens recall button, and a first focus storage unit. According to Japanese Patent Application Laid-Open No. 2023-141434, when the lens preset button is operated, the current focus position is stored in the first focus storage unit as a first registered position. When the lens recall button is operated, the first registered position is recalled.

### SUMMARY

According to an aspect of the embodiments, there is provided a system including a lens apparatus and a camera apparatus. The lens apparatus includes a focus lens, a first operation unit that is assigned a first function of moving the focus lens to a first focus position stored in a storage unit of the lens apparatus in advance, and a second operation unit, the second operation unit being configured to accept an operation for executing adjustment processing to move the focus lens to a focus position based on operation on the second operation unit. The camera apparatus includes a third operation unit that is assigned a second function of moving the focus lens to a second focus position stored in a storage unit of the camera apparatus in advance. The system further includes a first control unit configured to, while the focus lens is moving due to execution of the first function based on operation on the first operation unit, perform control so as not to execute the adjustment processing based on the operation on the second operation unit, and a second control unit configured to, while the focus lens is moving due to execution of the second function based on operation on the third operation unit, perform control to switch execution and non-execution of the adjustment processing based on the operation on the second operation unit, depending on a predetermined setting of the camera apparatus.

Features of the disclosure will become apparent from the following description of embodiments with reference to the attached drawings. The following description of embodiments is described by way of example.

### BRIEF DESCRIPTION OF THE DRAWINGS

FIG. 1 is a block diagram illustrating a configuration of a camera system according to a first exemplary embodiment.

FIGS. 2A and 2B are external views of a camera main body that is an example of an imaging apparatus according to the first exemplary embodiment.

FIGS. 3A and 3B are flowcharts illustrating focus preset (FP) registration processing according to the first exemplary embodiment.

FIG. 4 is a flowchart illustrating FP recall processing of an imaging lens according to the first exemplary embodiment.

FIG. 5 is a flowchart illustrating FP recall processing of a camera main body according to the first exemplary embodiment.

FIGS. 6A and 6B are flowcharts related to the setting of manual focus adjustment processing availability based on a camera setting.

FIG. 7 is a flowchart related to manual focus adjustment processing.

FIGS. 8A and 8B are diagrams for describing switching of the manual focus adjustment processing availability based on a setting (mode) related to a manual focus adjustment operation.

FIGS. 9A and 9B are diagrams for describing a case where the user can inadvertently operate a focus ring during an FP recall operation.

FIG. 10 illustrates an example of a setting screen related to the manual focus adjustment operation while an FP recall function is in operation according to the present exemplary embodiment.

FIG. 11 is a flowchart illustrating FP recall processing of an imaging lens according to a second exemplary embodiment.

FIG. 12 is a flowchart illustrating FP recall processing of a camera main body according to the second exemplary embodiment.

### DESCRIPTION OF THE EMBODIMENTS

Exemplary embodiments of the disclosure will be described in detail below with reference to the attached drawings. In the exemplary embodiments, a focus preset (FP) registration operation to be described below and an FP recall operation to be described below may be referred to collectively as FP operations. An FP registration function to be described below and an FP recall function to be described below may be referred to collectively as FP functions.

### Configuration of Camera System 100

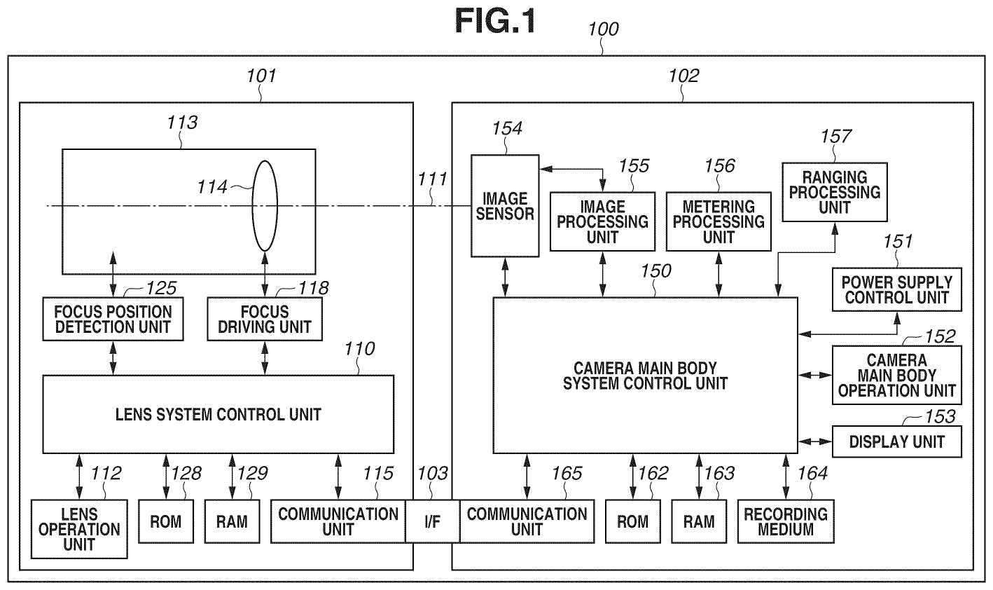

FIG. 1 is a block diagram illustrating a configuration of a camera system 100 according to a first exemplary embodiment. For example, the camera system 100 is an imaging apparatus such as a digital single-lens reflex camera.

The camera system 100 includes an imaging lens (imaging lens apparatus) 101 and a camera main body (camera apparatus) 102. The camera main body 102 can communicate with the imaging lens 101.

The imaging lens 101 and the camera main body 102 are connected via an interface (I/F) 103. The imaging lens 101 is an interchangeable lens that can be mounted on the camera main body 102.

### Configuration of Imaging Lens 101

A lens system control unit 110 performs system control of the imaging lens 101.

A read-only memory (ROM) 128 is a nonvolatile memory storing a control program executable by the lens system control unit 110. The ROM 128 also stores various types of information and setting values.

A random access memory (RAM) 129 is a volatile memory to be used as a work memory when the lens system control unit 110 executes the control program stored in the ROM 128.

The imaging lens 101 includes a lens group 113 including a plurality of lenses such as a focus lens 114 for adjusting a focus position. The focus lens 114 is held by a lens holding frame (not illustrated). The lens holding frame can be driven in the direction of an optical axis 111 by an actuator (not illustrated).

A lens operation unit 112 is an operation mechanism for inputting various operation instructions to the lens system control unit 110. The lens operation unit 112 includes one or a combination of more than one of buttons, switches, and dials. When the lens operation unit 112 is operated, the operation is notified to the lens system control unit 110, and the lens system control unit 110 performs processing corresponding to the notified operation.

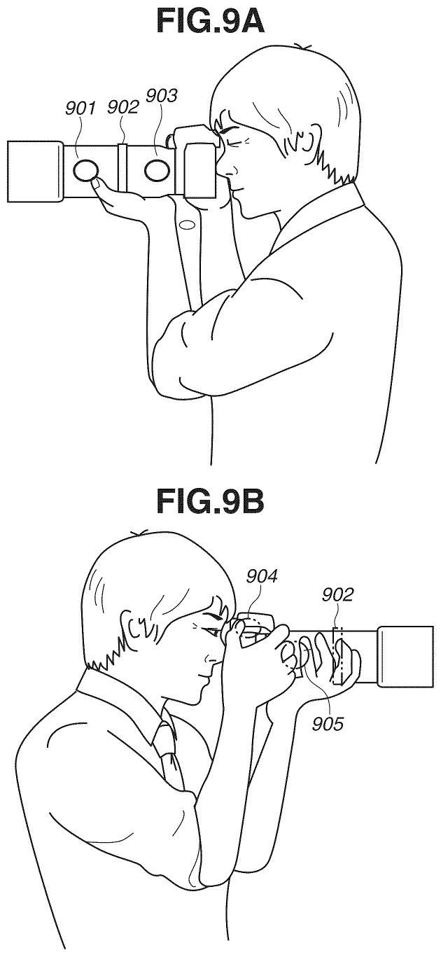

The lens operation unit 112 includes a lens FP registration button for registering a focus position obtained by a focus position detection unit 125 to be described below in the imaging lens 101, and a lens FP recall button 903 for recalling the focus position registered in the imaging lens 101. The lens operation unit 112 also includes a focus ring 902 (FIG. 9A). The focus ring 902 enables manual adjustment of the focus position. The focus position can be moved based on the amount of movement (amount of rotation) of the focus ring 902. The lens operation unit 112 may also include a not-illustrated playback ring. The lens FP recall function may be assigned to the playback ring. If the playback ring is assigned the lens FP recall function, focus positions registered in the imaging lens 101 can be recalled based on the rotational operation of the playback ring. In the present exemplary embodiment, the imaging lens 101 will be described to include a lens FP registration button and a lens FP recall button. However, a single button may be used both as a lens FP registration button and a lens FP recall button. In such a case, which for the button to function as, the lens FP registration button or the lens FP recall button, may be switched using a switch or other operation unit disposed on the imaging lens 101.

The lens operation unit 112 of the imaging lens 101 includes a custom button. This custom button can be assigned a camera FP recall function of recalling a focus position registered in the camera main body 102.

A communication unit 115 communicates with the camera main body 102 via the I/F 103. The communication unit 115 thereby receives focus driving instructions and information such as manual focus adjustment processing availability from the camera main body 102, transmits a focus lens driving state to the camera main body 102, and communicates various types of information and instructions.

A focus driving unit 118 changes the focus position of the focus lens 114 by controlling the actuator to move the lens holding frame in the direction of the optical axis 111.

A focus position detection unit 125 manages the position of the focus lens 114 and thereby detects the current focus position of the focus lens 114. The function of the focus position detection unit 125 may be implemented by the lens system control unit 110.

### Configuration of Camera Main Body 102

A camera main body system control unit 150 performs system control of the camera main body 102.

An image sensor 154 is a charge-coupled device (CCD) sensor or a complementary metal-oxide-semiconductor (CMOS) sensor. The image sensor 154 photoelectrically converts an object image formed by an imaging optical system in the lens apparatus 101 and outputs an electrical signal (analog signal).

An image processing unit 155 converts the analog signal from the image sensor 154 into a digital signal and performs various types of image processing to generate image data. The image processing unit 155 generates focus information indicating a contrast state of the object image (focus state of the imaging optical system) and luminance information indicating an exposure state from the image data. The image processing unit 155 outputs the image data to a display unit 153. The display unit 153 displays the image data as a live-view image for use in checking composition and an in-focus state.

A power supply control unit 151 includes a battery detection circuit, a direct-current-to-direct-current (DC-DC) converter, and a switch circuit for switching blocks to be energized. The power supply control unit 151 detects the presence or absence of battery connection, the type of battery, and the remaining battery level. Based on the detection results and instructions from the camera main body system control unit 150, the power supply control unit 151 controls the not-illustrated DC-DC converter and supplies the components of the camera system 100 with predetermined voltages for predetermined periods.

A camera main body operation unit 152 is an operation mechanism for inputting various operation instructions to the camera main body system control unit 150. The camera main body operation unit 152 includes one or a combination of more than one of buttons, switches, dials, touchscreens, and line-of-sight detection pointing devices. When the camera main body operation unit 152 is operated, the operation is notified to the camera main body system control unit 150. The camera main body system control unit 150 performs processing based on the notified operation.

For example, the camera main body operation unit 152 includes a shutter button 61, a multifunction button 71, an illumination button 80, a moving image capturing button 81, an automatic focus (AF)-ON button 82, an automatic exposure (AE) lock button 83, an AF frame selection button 84, and a set button 85. Of these, the multifunction button 71, the illumination button 80, the moving image capturing button 81, the AF-ON button 82, the AE lock button 83, and the AF frame selection button 84 can be assigned the following functions by user setting as functions to be executed upon pressing operation. The functions are a camera FP registration function of registering a focus position in the camera main body 102 and a camera FP recall button of recalling the focus position registered in the camera main body 102. Buttons that are thus assigned the camera FP registration function of registering a focus position in the camera main body 102 will be referred to collectively as camera FP registration buttons. Buttons that are assigned the camera FP recall function of recalling a focus position registered in the camera main body 102 will be referred to collectively as camera FP recall buttons.

The display unit 153 displays setting screens for configuring various settings configurable in various functional imaging modes, including exposure parameters and step number settings. The user can configure various settings by operating the camera main body operation unit 152 while viewing the setting screens displayed on the display unit 153. The display unit 153 can also display image data that is captured by the image sensor 154 and image-processed by the image processing unit 155 as a live-view image.

A communication unit 165 can communicate with the imaging lens 101 via the I/F 103 and transmit focus driving instructions and information such as the manual focus adjustment processing availability to the imaging lens 101. The communication unit 165 can also receive the focus lens driving state from the imaging lens 101, and communicates various types of information and instructions.

A metering processing unit 156 performs exposure processing using rays incident from the imaging lens 101, and sets exposure parameters (aperture value, shutter speed, and International Organization for Standardization [ISO] value).

A ranging processing unit 157 performs focusing processing using the rays incident from the imaging lens 101 in response to a pressing operation on the shutter button 61.

A ROM 162 is a nonvolatile memory storing a control program executable by the camera main body system control unit 150.

A RAM 163 is a volatile memory to be used as a work memory when the camera main body system control unit 150 executes the control program stored in the ROM 162.

A recording medium 164 records images captured by the camera system 100.

### Appearance of Camera Main Body 102

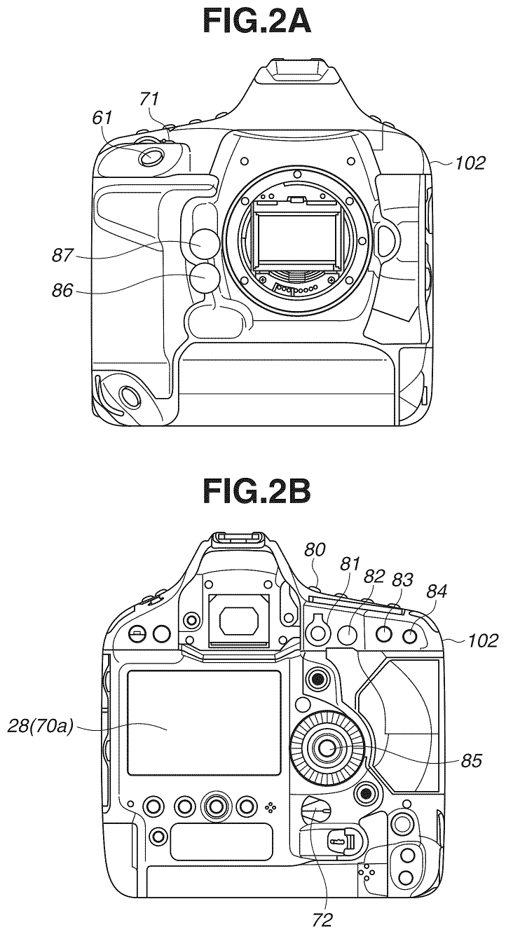

FIGS. 2A and 2B are external views of the camera main body 102 according to the present exemplary embodiment. FIG. 2A is a diagram illustrating an external shape of the camera main body 102 as viewed from the front. FIG. 2B is a diagram illustrating the external shape of the camera main body 102 as viewed from behind.

A display unit 28 is a display unit disposed on the rear of the camera main body 102, and displays images and various types of information. A touchscreen 70a can detect touch operations on the display surface (touch operation surface) of the display unit 28.

The shutter button 61 is an operation member for giving an imaging preparation instruction and an imaging instruction. The shutter button 61 is half-pressed to measure the luminance of the object and perform focusing. The shutter button 61 is fully pressed to release the shutter and capture an image.

The multifunction button 71 is a push button.

The illumination button 80 is a push button and can switch on/off the illumination of light-emitting diodes (LEDs) for making the operation unit 152 visible even in dark places and the illumination of an extra-viewfinder display unit.

The moving image capturing button 81 is used to issue start and stop instructions for moving image capturing (recording).

The AF-ON button 82 is a push button and can issue AF execution instructions when pressed.

The AE lock button 83 is a push button. The exposure state can be locked by pressing the AE lock button 81 in an imaging standby state.

The AF frame selection button 84 is a push button. The AF frame selection button 84 enables selection of an AF position (frame) to focus on through operation of a not-illustrated directional keypad.

The set button 85 is a push button and mainly used to determine a selected item.

The buttons that can be assigned the camera FP recall function are the multifunction button 71, the illumination button 80, the moving image capturing button 81, the AF-ON button 82, the AE lock button 83, and the AF frame selection button 84. A button 86 located on the front of the camera main body 102 can also be assigned the camera FP recall function. In FIG. 9B, the AF-ON button 82 is denoted by the reference numeral 904.

A button 87 located on the front of the camera main body 102 can be assigned the camera FP registration function.

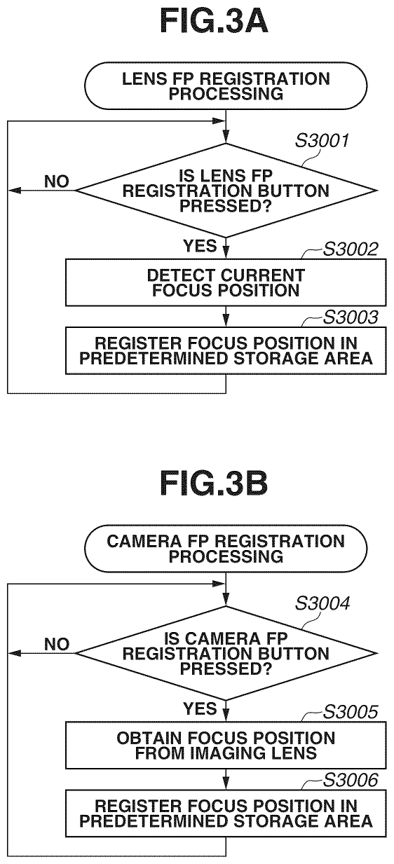

The camera system 100 performs processes illustrated in FIGS. 3A to 7 to be described below. These processes are executed when the camera main body 102 is in an imaging mode. During the imaging mode, the processes illustrated in FIGS. 3A to 7 are performed in parallel.

### FP Registration Processing

FIGS. 3A and 3B are flowcharts illustrating FP registration processing according to the present exemplary embodiment.

### Lens FP Registration Processing

FIG. 3A is a flowchart illustrating lens FP registration processing for registering a focus position in the imaging lens 101. The processing of FIG. 3A is implemented by loading the control program recorded in the ROM 128 into the RAM 129 and the lens system control unit 110 controlling the components of the imaging lens 101 and performing calculation processing based on the control program.

In step S3001, the lens system control unit 110 determine whether the lens FP registration button included in the lens operation unit 112 of the imaging lens 101 is pressed. If the lens FP registration button included in the lens operation unit 112 of the imaging lens 101 is determined to be pressed (YES in step S3001), the processing proceeds to step S3002. If not (NO in step S3001), the processing proceeds to step S3001.

In step S3002, the focus position detection unit 125 of the imaging lens 101 detects the current focus position of the focus lens 114 and notifies the lens system control unit 110 of the current focus position.

In step S3003, the lens system control unit 110 registers (records) the focus position detected in step S3002 in a predetermined storage area (such as the ROM 128 and the RAM 129) of the imaging lens 101. The processing of steps S3002 and S3003 is performed each time the lens FP registration button is pressed.

### Camera FP Registration Processing

FIG. 3B is a flowchart illustrating camera FP registration processing for registering a focus position in the camera main body 102. The processing of FIG. 3B is implemented by loading the control program recorded in the ROM 162 into the RAM 163 and the camera main body system control unit 150 controlling the components of the camera main body 102 and performing calculation processing based on the control program.

In step S3004, the camera main body system control unit 150 determines whether a camera FP registration button of the camera main body 102 to which the camera FP registration function is assigned is pressed. If a camera FP registration button is determined to be pressed (YES in step S3004), the processing proceeds to step S3005. If not (NO in step S3004), the processing proceeds to step S3004.

In step S3005, the camera main body system control unit 150 communicates with the imaging lens 101 via the communication unit 115 of the imaging lens 101 and obtains the current focus position of the focus lens 114 detected by the focus position detection unit 125 of the imaging lens 101. If the current focus position of the focus lens 114 has already been obtained and stored in the camera main body 102, the camera main body system control unit 150 may obtain the focus position stored in the camera main body 102.

In step S3006, the camera main body system control unit 150 registers the obtained current focus position in a predetermined storage area (such as the ROM 162, RAM 163, and recording medium 164) of the camera main body 102. The processing returns to step S3004. The processing of steps S3005 and S3006 is performed each time a camera FP registration button is pressed.

As described above, in the FP registration processing, the current focus position upon the registration processing is registered (recorded) in a predetermined storage area of the imaging lens 101 or the camera main body 102. While in the exemplary embodiment the detected focus position is described to be registered in a predetermined storage area of the imaging lens 101 or the camera main body 102, the focus position may be registered in an external storage if the camera system 100 is connected to the external storage via a network.

As described above, in the present exemplary embodiment, the focus position is registered in respective different predetermined storage areas depending on the functionality to be implemented by the FP operation. Alternatively, if the focus position can be registered in a manner to distinguish between the imaging lens 101 and the camera main body 102, the same storage area may be used regardless of the functionality to be implemented by the FP operation.

### FP Recall Processing

### FP Recall Processing of Imaging Lens 101

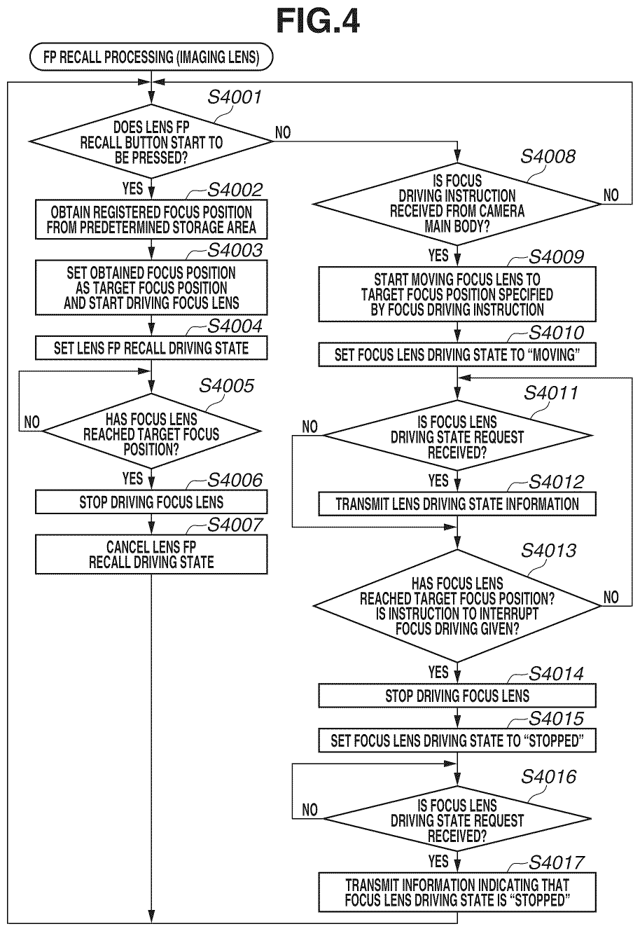

FIG. 4 is a flowchart illustrating FP recall processing of the imaging lens 101 according to the present exemplary embodiment. The processing FIG. 4 is implemented by loading the control program recorded in the ROM 128 into the RAM 129 and the lens system control unit 110 controlling the components of the imaging lens 101 and performing calculation processing based on the control program.

In step S4001, the lens system control unit 110 determines whether the lens FP recall button of the lens operation unit 112 starts to be pressed, i.e., the lens FP recall button is switched from a non-pressed state to a pressed state. If the lens FP recall button is determined to start to be pressed (YES in step S4001), the processing proceeds to step S4002. If not (NO in step S4001), the processing proceeds to step S4008. If the FP recall function is assigned to the playback ring operation, then in step S4001, the lens system control unit 110 may determine whether the playback ring is operated, aside from whether the lens FP recall button starts to be pressed.

In step S4002, the lens system control unit 110 obtains the focus position registered in the predetermined storage area (ROM 128 or RAM 129) of the imaging lens 101 in step S3003.

In step S4003, the lens system control unit 110 sets the focus position obtained in step S4002 for the focus driving unit 118 as a target focus position. The focus driving unit 118 starts driving the focus lens 114. Specifically, the focus driving unit 118 starts moving the focus lens 114 from the focus position when the lens FP recall button starts to be pressed to the target focus position.

In step S4004, the lens system control unit 110 sets a lens FP recall driving state. More specifically, the lens system control unit 110 retains, in the RAM 129, information indicating that the focus lens 114 is currently being driven by the lens FP recall processing as the current state of the imaging lens 101.

In step S4005, the focus driving unit 118 determines whether the focus lens 114 has reached the target focus position. If the focus lens 114 is determined to have reached the target focus position (YES in step S4005), the processing proceeds to step S4006. If not (NO in step S4005), the processing proceeds to step S4005.

In step S4006, the focus driving unit 118 stops driving (moving) the focus lens 114.

In step S4007, the lens system control unit 110 cancels the lens FP recall driving state in response to the movement of the focus lens 114 by the focus driving unit 118 being stopped in step S4006. More specifically, the lens system control unit 110 deletes the information indicating that the focus lens 114 is being driven by the FP recalling processing, retained in the RAM 129 in step S4004. The processing then returns to step S4001.

In step S4008, the lens system control unit 110 determines whether the communication unit 115 receives a focus driving instruction from the camera main body 102. This focus driving instruction corresponds to one transmitted from the camera main body 102 to the imaging lens 101 in step S5003 to be described below. The focus driving instruction includes information about a target focus position. If the focus driving instruction is determined to be received (YES in step S4008), the processing proceeds to step S4009. If not (NO in step S4008), the processing proceeds to step S4001.

In step S4009, the lens system control unit 110 sets the target focus position included in the focus driving instruction received in step S4008 for the focus driving unit 118. The focus driving unit 118 starts focus driving toward the set target focus position. Specifically, the focus driving unit 118 starts moving the focus lens 114 from the current focus position to the target focus position.

In step S4010, the lens system control unit 110 sets the focus lens driving state to “moving”.

In step S4011, the lens system control unit 110 determines whether the communication unit 115 receives a focus lens driving state request from the camera main body 102. This focus lens driving state request corresponds to one transmitted from the camera main body 102 in step S5004 to be described below. If a focus lens driving state request is determined to be received from the camera main body 102 (YES in step S4011), the processing proceeds to step S4012. If not (NO in step S4011), the processing proceeds to step S4013.

In step S4012, the lens system control unit 110 transmits information (lens driving state information) indicating that the focus lens driving state is “moving” to the camera main body 102 as a response to the focus lens driving state request received by the communication unit 115 in step S4011.

In step S4013, the lens system control unit 110 determines whether the focus lens 114 has reached the target focus position and whether an instruction to interrupt (stop) the focus driving is given. If the focus lens 114 is determined to have reached the target focus position or if an instruction to interrupt the focus driving (focus driving stop instruction) is determined to be given (YES in step S4013), the processing proceeds to step S4014. If not (NO in step S4013), the processing proceeds to step S4011. The focus driving interruption (stop) instruction corresponds to one given by focus driving stop processing of step S7005 to be described below.

In step S4014, the focus driving unit 118 stops driving the focus lens 114 (moving the focus position). When the focus driving stop processing is performed in step S7005 and the focus driving stop instruction is given, the camera FP recall processing is thus interrupted in step S4014.

In step S4015, the lens system control unit 110 sets the focus lens driving state to “stopped”.

In stop S4016, the lens system control unit 110 determines whether the communication unit 115 receives a focus lens driving state request from the camera main body 102. If a focus lens driving state request is determined to be received (YES in step S4016), the processing proceeds to step S4017. If not (NO in step S4016), the processing proceeds to step S4016. This focus lens driving state request corresponds to one transmitted from the camera main body 102 in step S5004 to be described below.

In step S4017, the lens system control unit 110 transmits information indicating that the focus lens driving state is “stopped” to the camera main body 102 via the communication unit 115 as a response to the focus lens driving state request received in step S4016.

### FP Recall Processing of Camera Main Body 102

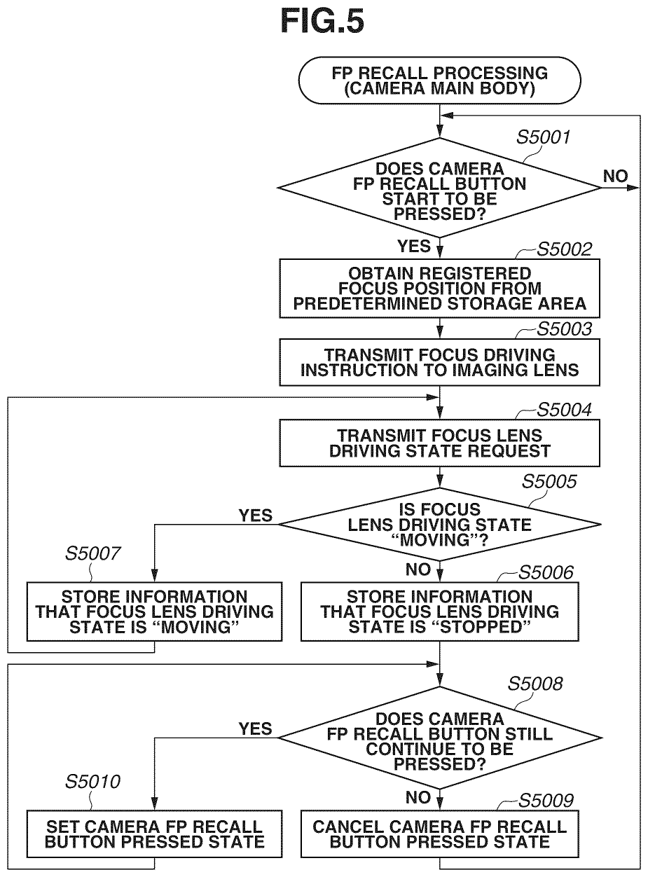

FIG. 5 is a flowchart illustrating FP recall processing of the camera main body 102 according to the first exemplary embodiment. The processing of FIG. 5 is implemented by loading the control program recorded in the ROM 162 into the RAM 163 and the camera main body system control unit 150 controlling the components of the camera main body 102 and performing calculation processing based on the control program.

In step S5001, the camera main body system control unit 150 determines whether a camera FP recall button of the camera main body operation unit 152 starts to be pressed, i.e., a camera FP recall button is switched from a non-pressed state to a pressed state. If a camera FP recall button is determined to start to be pressed (YES in step S5001), the processing proceeds to step S5002. If not (NO in step S5001), the processing proceeds to step S5001.

In step S5002, the camera main body system control unit 150 obtains the focus position registered in the predetermined storage area (such as the ROM 162, RAM 163, and recording medium 164) of the camera main body 102 in step S3006.

In step S5003, the camera main body system control unit 150 transmits a focus driving instruction to the imaging lens 101 via the communication unit 165. The focus driving instruction transmitted includes information that the focus position obtained in step S5002 is the target focus position.

In step S5004, the camera main body system control unit 150 transmits a focus lens driving state request to the imaging lens 101 via the communication unit 165.

In step S5005, the camera main body system control unit 150 receives the information about the focus lens driving state, transmitted from the imaging lens 101 by the processing of the imaging lens 101 in step S4012 or S4017. In other words, in step S5005, the camera main body system control unit 150 receives the information about the focus lens driving state as a response to the focus lens driving state request transmitted to the imaging lens 101 in step S5004. The camera main body system control unit 150 then determines whether the received focus lens driving state is “moving” or “stopped”. If the focus lens driving state is determined to be “stopped” (NO in step S5005), the processing proceeds to step S5006. If the focus lens driving state is determined to be “moving” (YES in step S5005), the processing proceeds to step S5007.

In step S5006, the camera main body system control unit 150 stores the information that the focus lens driving state is “stopped” in the camera main body 102. Specifically, the camera main body system control unit 150 stores the information indicating “stopped” in an area intended to store the focus lens driving state in the RAM 163. The processing then proceeds to step S5008.

In step S5007, the camera main body system control unit 150 stores the information that the focus lens driving state is “moving” in the camera main body 102. Specifically, the camera main body system control unit 150 stores the information indicating “moving” in the area intended to store the focus lens driving state in the RAM 163. The processing then proceeds to step S5004. In other words, if the focus lens driving state is “moving”, the processing of steps S5004 to S5007 is repeated.

In step S5008, the camera main body system control unit 150 determines whether the camera FP recall button started in step S5001 still continues to be pressed. If the camera FP recall button is determined to continue to be pressed (YES in step S5008), the processing proceeds to step S5010. If not (NO in step S5008), the processing proceeds to step S5009.

In step S5010, the camera main body system control unit 150 stores information indicating that the camera FP recall button is in a pressed state in the RAM 163, thereby setting a camera FP recall button pressed state. The processing proceeds to step S5008.

In step S5009, the camera main body system control unit 150 deletes the information indicating that the camera FP recall button is in the pressed state from the RAM 163, thereby cancelling the camera FP recall button pressed state. The processing proceeds to step S5001.

### Setting of Availability of Manual Focus Adjustment Processing by Manual Focus Adjustment Operation Based on Camera Settings

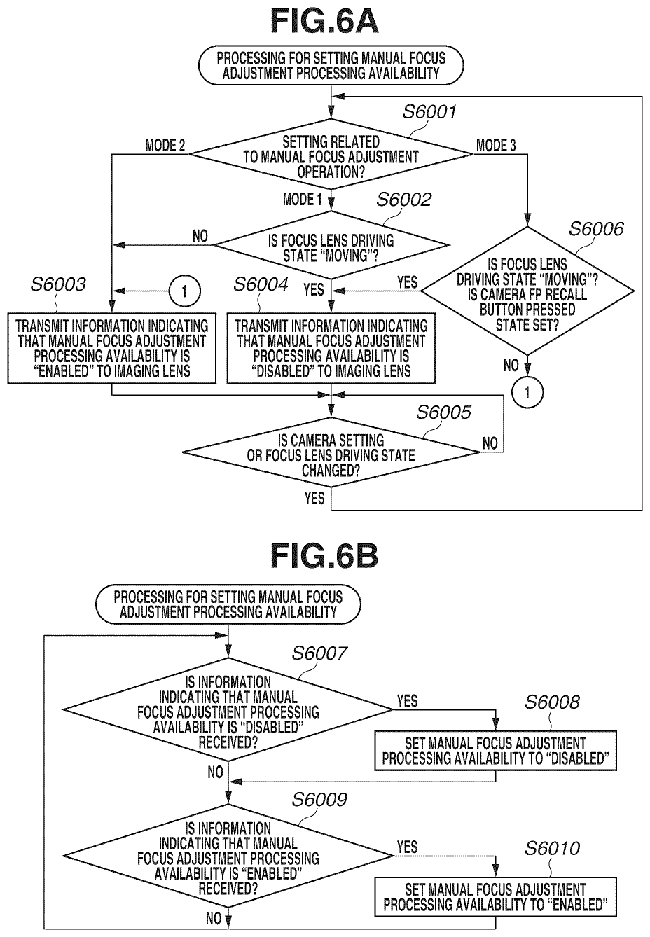

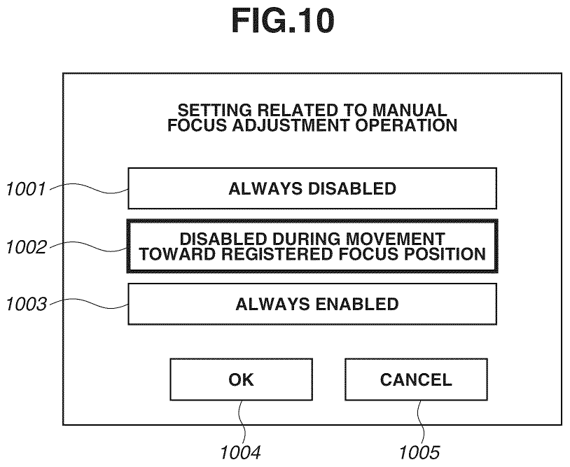

FIGS. 6A and 6B are flowcharts related to the setting of the availability of manual focus adjustment processing by a manual focus adjustment operation based on camera settings. As employed herein, the manual focus adjustment operation refers to the operation of the focus ring 902. The setting of availability of the manual focus adjustment processing by the manual focus adjustment operation refers to a setting for switching whether to execute processing for driving the focus lens 114 based on the amount of operation (amount of rotation) when the focus ring 902 is operated (operated to rotate). FIG. 10 illustrates an example of a setting screen related to the manual focus adjustment operation.

### Settings Related to Manual Focus Adjustment Operation

Possible settings related to the manual focus adjustment operation on the camera main body 102 will be described with reference to FIG. 10. The setting screen of FIG. 10 related to the manual focus adjustment operation is a part of menu screens of the camera main body 102, and displayed on the display unit 153. One of settings 1001 to 1003 can be selected and set for the camera main body 102 based on user operation on the camera main body operation unit 152.

A setting item 1001 (mode 3) is intended to constantly disable the acceptance of the manual focus adjustment operation while camera FP recall button operation is on (a camera FP recall button is operated) regardless of the focus lens driving state.

A setting item 1002 (mode 1) is intended to disable the acceptance of the manual focus adjustment operation when the focus lens driving state is “moving”, and enable the acceptance of the manual focus adjustment operation when the focus lens driving state is not “moving”.

A setting item 1003 (mode 2) is intended to constantly enable the acceptance of the manual focus adjustment operation regardless of the focus lens driving state or whether the camera FP recall button operation is on or off.

An OK button 1004 is intended to, when pressed by the user, update the setting related to the manual focus adjustment operation with the content of the selected setting item (thick-framed) and exit this setting screen.

A cancel button 1005 is intended to, when pressed by the user, exit this setting screen without updating the setting related to the manual focus adjustment operation.

FIG. 10 illustrates a state where the setting item 1002 for disabling the acceptance of the manual focus adjustment operation during movement toward the target focus position is surrounded by the thick frame. When the OK button 1004 is pressed in this state, the camera main body system control unit 150 configures the setting to disable the acceptance of the manual focus adjustment operation during movement toward the target focus position, and exits the setting screen.

### Processing for Setting Manual Focus Adjustment Processing Availability by Camera Main Body 102

The processing of FIG. 6A is implemented by loading the control program recorded in the ROM 162 into the RAM 163 and the camera main body system control unit 150 controlling the components of the camera main body 102 and performing calculation processing based on the control program.

In step S6001, the camera main body system control unit 150 determines which mode the setting related to the manual focus adjustment operation configured on the setting screen of FIG. 10 is. If the setting related to the manual focus adjustment operation is mode 1 (1002) (MODE 1 in step S6001), the processing proceeds to step S6002. If the setting is mode 2 (1003) (MODE 2 in step S6001), the processing proceeds to step S6003. If the setting is mode 3 (1001) (MODE 3 in step S6001), the processing proceeds to step S6006.

In step S6002, the camera main body system control unit 150 reads the focus lens driving state from the RAM 163, and determines whether the focus lens driving state is “moving” or “stopped”. This focus lens driving state is the information stored in the RAM 163 by the processing of steps S5004 to S5007. If the focus lens driving state is determined to be “moving” (YES in step S6002), the processing proceeds to step S6004. If the focus lens driving state is determined to be “stopped” (NO in step S6002), the processing proceeds to step S6003.

In step S6003, to set the manual focus adjustment processing availability to “enabled”, the camera main body system control unit 150 transmits information (availability information) indicating that the manual focus adjustment processing availability is “enabled” to the imaging lens 101 via the communication unit 165.

In step S6004, to set the manual focus adjustment processing availability to “disabled”, the camera main body system control unit 150 transmits information (availability information) indicating that the manual focus adjustment processing availability is “disabled” to the imaging lens 101 via the communication unit 165.

In step S6005, the camera main body system control unit 150 determines whether the camera setting related to the manual focus adjustment operation is changed and whether the focus lens driving state obtained from the imaging lens 101 and stored in the RAM 163 is changed. If the camera setting related to the manual focus adjustment operation is determined to be changed or if the focus lens driving state is determined to be changed (YES in step S6005), the processing proceeds to step S6001 to repeat this flowchart.

In step S6006, the camera main body system control unit 150 determines whether the focus lens driving state is “moving” (first condition) and whether the camera FP recall button pressed state is set (second condition). If the focus lens driving state is determined to be “moving” or if the camera FP recall button pressed state is determined to be set (YES in step S6006), the processing proceeds to step S6004. If the focus lens driving state is determined to be “stopped” and the camera FP recall button pressed state is determined to not be set (NO in step S6006), the processing proceeds to step S6003.

The camera setting or the focus lens driving state can be changed after the information about the manual focus adjustment processing availability is transmitted in step S6003 or S6004. Even in such a case, the information about the manual focus adjustment processing availability does not need to be transmitted to the imaging lens 101 unless the manual focus adjustment processing availability is changed.

As described above, in this processing, the camera main body 102 sets the manual focus adjustment processing availability based on the setting related to the manual focus adjustment operation, the focus lens driving state, and the camera FP recall button pressed state. The camera main body 102 then transmits the information about the manual focus adjustment processing availability to the imaging lens 101.

### Processing for Setting Manual Focus Adjustment Processing Availability by Imaging Lens 101

The processing of FIG. 6B is implemented by loading the control program recorded in the ROM 128 into the RAM 129 and the lens system control unit 110 controlling the components of the imaging lens 101 and performing calculation processing based on the control program.

In step S6007, the lens system control unit 110 transmits whether the information indicating that the manual focus adjustment processing availability is “disabled” is transmitted from the camera main body 102 in the processing of step S6004 and received by the communication unit 115. If the information that the manual focus adjustment processing availability is “disabled” is determined to be received (YES in step S6007), the processing proceeds to step S6008. If not (NO in step S6007), the processing proceeds to step S6009.

In step S6008, the lens system control unit 110 sets the manual focus adjustment processing availability to “disabled”.

In step S6009, the lens system control unit 110 determines whether the information indicating that the manual focus adjustment processing availability is “enabled” is transmitted from the camera main body 102 in the processing of step S6003 and received by the communication unit 115. If the information that the manual focus adjustment processing availability is “enabled” is determined to be received (YES in step S6009), the processing proceeds to step S6010. If not (NO in step S6009), the processing proceeds to step S6007.

In step S6010, the lens system control unit 110 sets the manual focus adjustment processing availability to “enabled”.

### Manual Focus Adjustment Processing

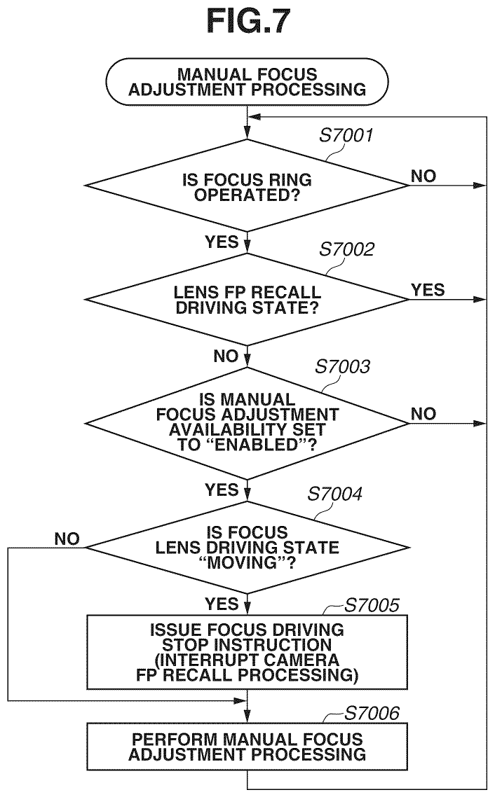

The processing of FIG. 7 is implemented by loading the control program recorded in the ROM 128 into the RAM 129 and the lens system control unit 110 controlling the components of the imaging lens 101 and performing calculation processing based on the control program.

In step S7001, the lens system control unit 110 determines whether the focus ring 902 is operated. If the focus ring 902 is determined to be operated (YES in step S7001), the processing proceeds to step S7002. If not (NO in step S7001), the processing returns to step S7001.

In step S7002, the lens system control unit 110 determines whether the imaging lens 101 is in the lens FP recall driving state based on the information about the state of the imaging lens 101, stored into or deleted from the RAM 129 in step S4004 or S4007. If the imaging lens 101 is determined to be in the lens FP recall driving state (YES in step S7002), the processing returns to step S7001. In other words, in the lens FP recall driving state, no focus adjustment processing is performed even when the focus ring 902 is operated. If the imaging lens 101 is determined to not be in the lens FP recall driving state (NO in step S7002), the processing proceeds to step S7003.

In step S7003, the lens system control unit 110 determines the setting of the manual focus adjustment processing availability, set by the processing of steps S6007 to S6010. If the manual focus adjustment processing availability is set to be “enabled” (YES in step S7003), the processing proceeds to step S7004. If the manual focus adjustment processing availability is set to “disabled” (NO in step S7003), the processing returns to step S7001. In other words, if the manual focus adjustment processing availability is set to be “disabled”, no focus adjustment processing is performed even when the focus ring 902 is operated.

In step S7004, the lens system control unit 110 determines the focus lens driving state set by the processing of step S4010 or S4015. If the focus lens driving state is “moving” (YES in step S7004), the processing proceeds to step S7005. If the focus lens driving state is “stopped” (NO in step S7004), the processing proceeds to step S7006.

In step S7005, the lens system control unit 110 issues a focus driving stop instruction to the focus driving unit 118. With the focus driving stop instruction issued in step S7005, the camera FP recall processing being executed in response to the operation of the camera FP recall button is interrupted in step S4014.

In step S7006, the lens system control unit 110 performs focus adjustment processing (manual focus adjustment processing) based on the operation of the focus ring 902 determined in step S7001. Specifically, the lens system control unit 110 detects the amount of operation (amount of rotation) of the focus ring 902, and drives (moves) the focus lens 114 by an amount corresponding to the amount of operation using the focus driving unit 118. In other words, the focus lens 114 is moved to the focus position corresponding to the operation of the focus ring 902 and the current focus position.

As described above, in this processing, if the imaging lens 101 is in the lens FP recall driving state where the FP recall processing based on the operation on the lens FP recall button is in operation, the manual focus adjustment processing is not performed even when the focus ring 902 is operated, regardless of the setting of the manual focus adjustment processing availability. In other words, in the lens FP driving state, the manual focus adjustment processing is not performed even when the focus ring 902 is operated, regardless of the setting related to the manual focus adjustment operation. By contrast, if the imaging lens 101 is not in the lens FP recall driving state, i.e., when the FP recall processing is being executed based on the operation of a camera FP recall button, the case is not the same as in the lens FP recall driving state. More specifically, whether to perform the manual focus adjustment processing based on the operation of the focusing ring 902 is switched depending on the setting of the manual focus adjustment processing availability. More specifically, whether to perform the manual focus adjustment processing based on the operation of the focus ring 902 is switched depending on the setting related to the manual focus adjustment operation, the camera FP recall operation, and the focus lens driving state.

### Relationship Between Camera FP Recall Operation, Focus Lens Driving State, and Manual Focus Adjustment Processing Availability

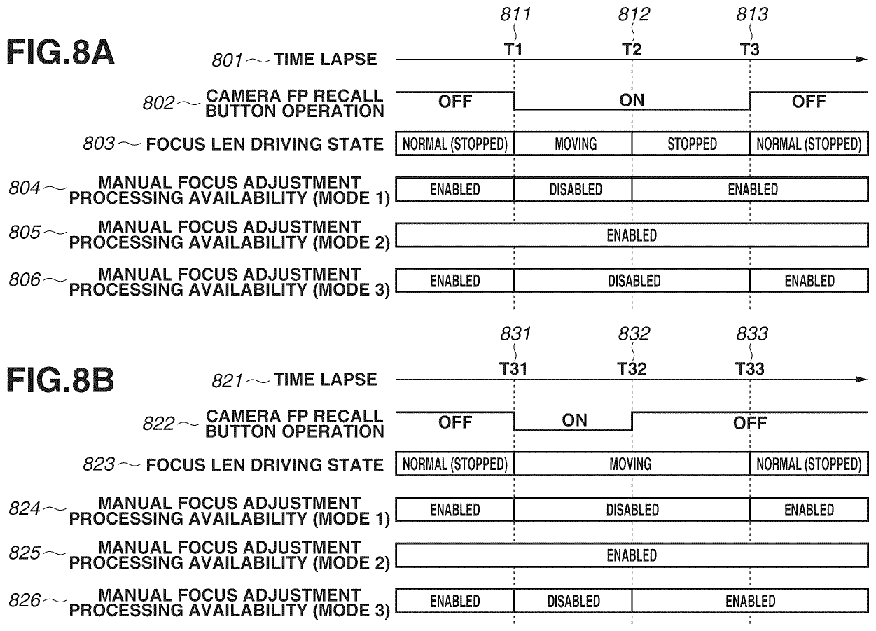

FIGS. 8A and 8B are timing charts illustrating a relationship between the camera FP recall operation, the focus lens driving state, and the manual focus adjustment processing availability. The switching of the manual focus adjustment processing availability based on the setting (mode) related to the manual focus adjustment operation will be described with reference to FIGS. 8A and 8B.

Time lapses 801 and 821 in FIGS. 8A and 8B are arrows indicating the lapse of time. The further to the right, the more time is indicated to have elapsed. Time T2 comes after time T1. Time T3 comes after time T2. T32 comes after time T31. Time T33 comes after time T32.

Camera FP recall button operations 802 and 822 in FIGS. 8A and 8B indicate the on and off operations of a camera FP recall button. The camera FP recall button operations 802 and 822 are on while a camera FP recall button is operated, i.e., a camera FP recall button is pressed. The camera FP recall button operations 802 and 822 are off while no camera FP recall button is operated, i.e., no camera FP recall button is pressed.

Focus lens driving states 803 and 823 in FIGS. 8A and 8B indicate the focus lens driving state. “Normal (stopped)” represents the state where no camera FP recall button is operated, i.e., the focus lens driving state is “stopped”.

Manual focus adjustment processing availabilities 804 and 824 in FIGS. 8A and 8B represent cases where mode 1 is set by the user. Manual focus adjustment processing availabilities 805 and 825 represent cases where mode 2 is set by the user. Manual focus adjustment processing availabilities 806 and 826 represent cases where mode 3 is set by the user. The manual focus adjustment processing availabilities are set to either “enabled” or “disabled”.

Time T1 811 and time T31 831 in FIGS. 8A and 8B indicate times when the camera FP recall button operations 802 and 822 are switched from off to on. Time T2 812 and time T33 833 indicate times when the current focus position reaches the target focus position. Time T3 813 and time T32 832 indicate times when the camera FP recall button operations 802 and 822 are switched from on to off.

FIG. 8A is a timing chart for the case of executing the FP recall processing based on the operation of a camera FP recall button, where the camera FP recall button continues to be operated even after the target focus position is reached, and then the camera FP recall button is released.

At time T1, the camera FP recall button operation 802 is switched from off to on, and the determination of step S5001 becomes YES. The processing of steps S5002, S5003, S4008, and S4009 is then performed, and the focus driving unit 118 starts moving the focus lens 114. The focus lens driving state 803 is then set to “moving” by the processing of step S4010.

At time T2, the focus lens 114 reaches the target focus position (YES in step S4013). The focus driving is stopped and the focus lens driving state 803 is set to “stopped” by the processing of steps S4014 and S4015.

The manual focus adjustment processing availability 804 represents the case where mode 1 is set by the user. In mode 1, the manual focus adjustment processing availability 804 is set to “enabled” during the periods before time T1 and after time T2, where the focus lens driving state 803 is “stopped”, by the processing of steps S6002 to S6004 and S6007 to S6010. By contrast, during the period from time T1 to time T2, where the focus lens driving state 803 is “moving”, the manual focus adjustment processing availability 804 is set to “disabled”. In mode 1, after the target focus position is reached, the manual focus adjustment can be performed even with the camera FP recall button operation 802 still on. This enables the user to fine-adjust the focus position for imaging by manually operating the focus ring 902 with reference to the target focus position.

The manual focus adjustment processing availability 805 represents the case where mode 2 is set by the user. In mode 2, the processing of steps S6003 and S6010 in the flowcharts of FIGS. 6A and 6B is performed regardless of the focus lens driving state or the operation state of the camera FP recall button. The manual focus adjustment processing availability 805 is thus set to “enabled” regardless of whether the focus lens driving state is “moving” or “stopped”. After the camera FP recall button is operated and the focus lens 114 starts to be moved toward the target focus position by the FP recall processing, the user may want to photograph another object before the target focus position is reached. In such a case, the movement toward the target focus position is interrupted by the processing of S7005 and S4014 so that the user can perform the manual focus adjustment processing by operating the focus ring 902. This enables quick focusing on another object.

The manual focus adjustment processing availability 806 represents the case where mode 3 is set by the user. In mode 3, if the camera FP recall button pressed state is determined to be set in step S6006, the processing of steps S6004 and S6008 is performed. During the period from times T1 to time T3, where the camera FP recall button is pressed, the manual focus adjustment processing availability 806 is thus “disabled”. In FIG. 8A, in the periods before time T1 and after T3, where the camera FP recall button pressed state is not set, the focus lens driving state is “stopped”. The processing of steps S6003 and S6010 is thus performed, and the manual focus adjustment processing availability 806 is set to “enabled”. The target focus position can thereby be maintained while the operation of the camera FP recall button by the user is on, not only until the focus lens 114 reaches the target focus position due to the FP recall processing but also after the target focus position is reached. This can ensure imaging at the target focus position.

Next, FIG. 8B will be described. FIG. 8B is a timing chart for the case of executing the FP recall processing based on the operation of a camera FP recall button, where the camera FP recall button is released before the target focus position is reached.

At time T31, the camera FP recall button operation 822 is switched from off to on, and the determination of step S5001 becomes YES. The processing of steps S5002, S5003, S4008, and S4009 is then performed, and the focus driving unit 118 starts moving the focus lens 114. The focus lens driving state 823 is then set to “moving” by the processing of step S4010.

At time T32, the camera FP recall button operation 822 is switched from on to off before the focus lens 114 reaches the target focus position. Since the focus lens 114 has not reached the target focus position at time T32 (NO in step S4013), the focus lens driving state 823 is maintained at “moving” by the processing of step S4010.

At time T33, the focus lens 114 reaches the target focus position (YES in step S4013), and the focus driving is stopped and the focus lens driving state 823 is set to “stopped” by the processing of steps S4014 and S4015.

The manual focus adjustment processing availability 824 represents the case where mode 1 is set by the user. In mode 1, the manual focus adjustment processing availability 824 is set to “enabled” during the periods before time T31 and after T33, where the focus lens driving state 823 is “stopped”, by the processing of steps S6002 to S6004 and S6007 to S6010. By contrast, during the period from time T31 to time T33, where the focus lens driving state is “moving”, the manual focus adjustment processing availability 824 is set to “disabled”. In mode 1, the manual focus adjustment can be performed once the target focus position is reached. This enables the user to fine-adjust the focus position for imaging by manually operating the focus ring 902 with reference to the target focus position.

The manual focus adjustment processing availability 825 represents the case where mode 2 is set by the user. In mode 2, the processing of steps S6003 and S6010 in the flowcharts of FIGS. 6A and 6B is performed regardless of the focus lens driving state and the operation state of the camera FP recall button. The manual focus adjustment processing availability 825 is thus set to “enabled” regardless of whether the focus lens driving state is “moving” or “stopped”. After the camera FP recall button is operated and the focus lens 114 starts to be moved toward the target focus position by the FP recall processing, the user may want to photograph another object before the target focus position is reached. In such a case, the movement toward the target focus position is interrupted by the processing of steps S7005 and S4014 so that the user can perform the manual focus adjustment processing by operating the focus ring 902. This enables quick focusing on another object.

The manual focus adjustment processing availability 826 represents the case where mode 3 is set by the user. In mode 3, if the camera FP recall button pressed state is determined to be set in step S6006, the processing of steps S6004 and S6008 is performed. The manual focus adjustment processing availability 826 is thus set to “disabled” during the period between times T31 and T32, where the camera FP recall button is pressed. In FIG. 8B, it is before time T31 and after time T32 that are the periods where the camera FP recall button pressed state is not set. The processing of steps S6003 and S6010 is thus performed, and the manual focus adjustment processing availability 826 is set to “enabled”. The target focus position can thus be maintained while the operation of the camera FP recall button by the user is on. By contrast, when the operation of the camera FP recall button by the user is off, the user can perform the manual focus adjustment processing by operating the focus ring 902 even before the target focus position is reached. This enables focusing on another object.

As described above, the camera system 100 according to the present exemplary embodiment, when performing the FP recall processing based on the operation on the camera FP recall button, changes the timing when the manual focus adjustment processing becomes available depending on the setting of the camera main body 102 related to the manual focus adjustment processing. This can prevent inadvertent operation and enables quick focus adjustment processing to suit the imaging situation and the user's intention so that imaging timing will not be missed.

### Inadvertent Operation of Focus Ring

The possibility of inadvertent operation of the focus ring 902 unintended by the user will be described with reference to FIGS. 9A and 9B.

FIG. 9A is a diagram for describing a case where the user can inadvertently operate the focus ring 902 during an FP recall operation. FIG. 9B is a diagram illustrating the user in FIG. 9A as viewed from the opposite side. In FIG. 9B, the focus ring 902 is hidden behind the user's hand and thus illustrated in dotted lines.

The imaging lens 101 includes the focus ring 902. The lens FP recall button disposed on the same imaging lens 101 is thus closer to the focus ring 902 than the camera FP recall buttons disposed on the camera main body 102.

The rotational operation of the focus ring 902 causes force toward the optical axis of the imaging lens 101 (in a direction perpendicular to the optical axis direction of the imaging lens 101). Similarly, the pressing operation of the lens FP recall button disposed on the imaging lens 101 also causes force toward the optical axis of the imaging lens 101 (in a direction perpendicular to the optical axis direction of the imaging lens 101). In other words, the direction of the pressing operation of the lens FP recall button interferes with the direction of the rotational operation of the focus ring 902.

When the focus lens driving state is “moving”, disabling the manual focus adjustment processing is thus considered to help preventing the user's inadvertent operation.

By contrast, the camera FP recall function is assigned to various buttons on the camera main body 102. Depending on the position of the camera FP recall buttons disposed on the camera main body 102, the direction of the pressing operation of the camera FP recall buttons may or may not interfere with the direction of the rotational operation of the focus ring 902. Whether the focus lens adjustment processing can be executed is therefore configured to be switchable based on the user's setting (modes 1 to 3).

### Modification of First Exemplary Embodiment

The setting related to the manual focus adjustment operation may be made configurable for still image capturing and moving image capturing separately. Different modes may be used depending on differences in the degree of impact on imaging.

For example, in the case of still image capturing, the camera FP recall button is often operated before imaging. Even if the user unintendedly discontinues the movement toward the target focus position, still image capturing can be started by operating the camera FP recall button again. By contrast, in the case of moving image capturing, the camera FP recall button can be operated during imaging. If the user unintendedly discontinues the movement toward the target focus position, in one embodiment, the moving image capturing is performed again. Modes 1, 2, and 3 may therefore be used differently depending on whether the imaging is still image capturing or moving image capturing.

The lens operation unit 112 of the imaging lens 101 includes a custom button. This custom button can be assigned an FP recall function of recalling a focus position registered in the camera main body 102. A second exemplary embodiment deal with the case of recalling the focus position registered in the camera main body 102 using the custom button. In recalling the focus position registered in the camera main body 102 using the custom button, whether the focus lens adjustment processing can be executed is switched based on the user's setting (modes 1 to 3). The second exemplary embodiment differs from the first exemplary embodiment in a part of the flowcharts illustrating the FP recall processing of the imaging lens 101 and the camera main body 102, and the rest is the same as the first exemplary embodiment.

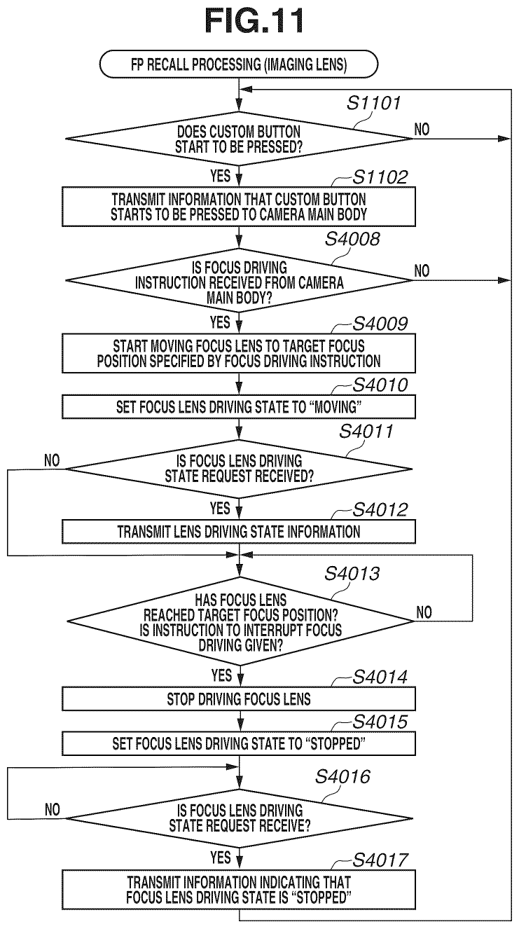

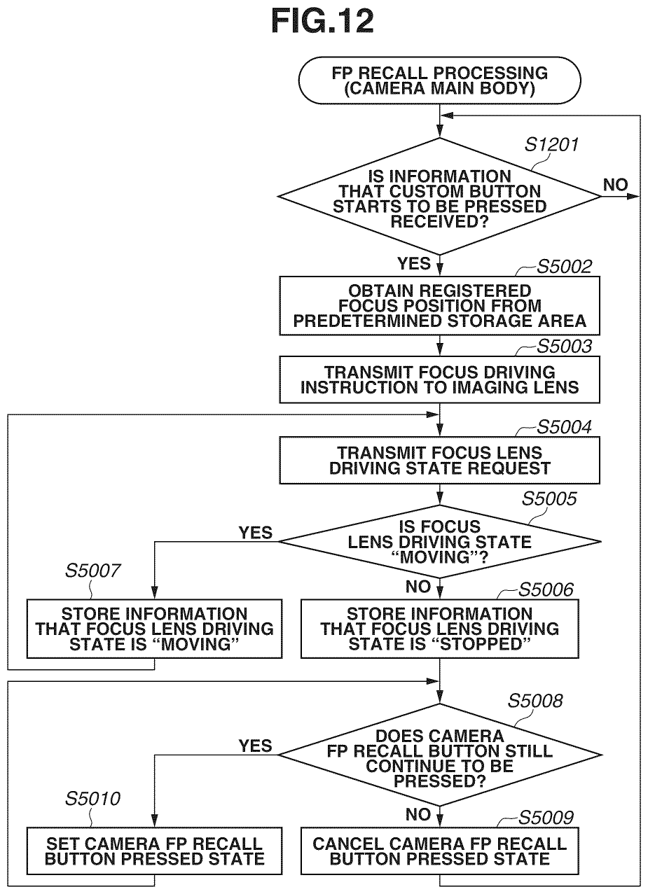

The processing for recalling the focus position registered in the camera main body 102 using the custom button will be described with reference to FIGS. 11 and 12 that include the different processing procedures. FIG. 11 is a flowchart illustrating the FP recall processing of the imaging lens 101 according to the second exemplary embodiment. The processing of FIG. 11 is implemented by loading a control program recording in the ROM 128 into the RAM 129 and the lens system control unit 110 controlling the components of the imaging lens 101 and performing calculation processing based on the control program.

The processing of FIG. 11 is similar to that of FIG. 4 except for steps S1101 and S1102. Only steps S1101 and S1102 will thus be described.

In step S1101, the lens system control unit 110 determines whether the custom button included in the lens operation unit 112 starts to be pressed. If the custom button is determined to start to be pressed (YES in step S1101), the processing proceeds to step S1102. If not (NO in step S1101), the processing proceeds to step S1101.

In step S1102, the lens system control unit 110 transmits information that the custom button starts to be pressed to the camera main body 102. The processing proceeds to step S4008.

FIG. 12 is a flowchart illustrating the FP recall processing of the camera main body 102 according to the second exemplary embodiment. The processing of FIG. 12 is implemented by loading a control program recorded in the ROM 162 into the RAM 163 and the camera main body system control unit 150 controlling the components of the camera main body 102 and performing calculation processing based on the control program.

The processing of FIG. 12 is similar to that of FIG. 5 except for step S1201. Only step S1201 will thus be described.

In step S1201, the camera main body system control unit 150 determines whether the information that the custom button included in the lens operation unit 112 starts to be pressed is received. If the information that the custom button starts to be pressed is determined to be received (YES in step S1201), the processing proceeds to step S5002. If not (NO in step S1201), the processing proceeds to step S1201.

### Other Modifications

The foregoing various controls described to be performed by the lens system control unit 110 and the camera main body system control unit 150 may be performed by a single piece of hardware. A plurality of pieces of hardware (for example, a plurality of processors or circuits) may control the entire camera system 100 by sharing processing.

In the foregoing exemplary embodiments, as illustrated in FIG. 6A, the camera main body system control unit 150 determines the manual focus adjustment processing availability based on the setting related to the manual focus adjustment operation, the focus lens driving state, and the camera FP recall button pressed state. The manual focus adjustment processing availability determined is then set for the imaging lens 101. However, the lens system control unit 110 may obtain the setting related to the manual focus adjustment operation and the camera FP recall button pressed state from the camera main body 102, and determine and set the manual focus adjustment processing availability. In such a case, the lens system control unit 110 controls the switching of whether the menu focus adjustment processing can be performed.

In the foregoing exemplary embodiments, as illustrated in FIG. 4, during the FP recall processing, the lens system control unit 110 determines whether the lens FP recall button is pressed, and sets or cancels the lens FP recall driving state based on the focus lens driving state. However, the driving of the focus lens 114 based on the pressing of the lens FP recall button and the pressing of the camera FP recall button may be controlled by the camera main body system control unit 150 instead of the lens system control unit 110. In such a case, the camera main body system control unit 150 obtains determination information about whether the lens FP recall button is pressed and the focus lens driving state from the imaging lens 101. The camera main body system control unit 150 may set or cancel the lens FP recall driving state based on the obtained information and state. The camera main body system control unit 150 may obtain information set by the imaging lens 101 via the communication unit 165. Similarly, the manual focus adjustment processing of FIG. 7 may be performed by the camera main body system control unit 150 instead of the lens system control unit 110. In such a case, the camera main body system control unit 150 obtains operation information about the focus ring 902 from the imaging lens 101. The camera main body system control unit 150 then controls the execution of the manual focus adjustment processing corresponding to the operation of the focus ring 902 based on the operation information about the focus ring 902, the information about the lens FP recall driving state, the manual focus adjustment processing availability, and the focus lens driving state.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-103358, filed Jun. 26, 2024, which is hereby incorporated by reference herein in its entirety.

What is claimed is:

1. A system comprising:
a lens apparatus; and
a camera apparatus,
the lens apparatus including:
a focus lens,
a first operation unit that is assigned a first function of moving the focus lens to a first focus position stored in a storage unit of the lens apparatus in advance; and
a second operation unit configured to accept an operation for executing adjustment processing to move the focus lens to a focus position based on operation on the second operation unit,
the camera apparatus including a third operation unit that is assigned a second function of moving the focus lens to a second focus position stored in a storage unit of the camera apparatus in advance,
the system further comprising:
a first control unit configured to, while the focus lens is moving due to execution of the first function based on operation on the first operation unit, perform control so as not to execute the adjustment processing based on the operation on the second operation unit; and
a second control unit configured to, while the focus lens is moving due to execution of the second function based on operation on the third operation unit, perform control to switch execution and non-execution of the adjustment processing based on the operation on the second operation unit, depending on a predetermined setting of the camera apparatus.

2. The system according to claim 1, wherein the first control unit is configured to, after the focus lens reaches the first focus position based on the operation on the first operation unit and stops moving, perform control to execute the adjustment processing based on the operation on the second operation unit regardless of whether the operation on the first operation unit continues.

3. The system according to claim 2, wherein the second control unit is configured to, after the focus lens reaches the second focus position based on the operation on the third operation unit and stops moving, perform control to switch execution and non-execution of the adjustment processing based on the operation on the second operation unit, depending on whether the operation on the third operation unit continues and the predetermined setting.

4. The system according to claim 1, wherein the second control unit is configured to:
in a case where the predetermined setting is a first setting, perform control so as not to execute the adjustment processing based on the operation on the second operation unit while the focus lens is moving due to the execution of the second function based on the operation on the third operation unit, and
in a case where the predetermined setting is a second setting, perform control to execute the adjustment processing based on the operation on the second operation unit while the focus lens is moving due to the execution of the second function based on the operation on the third operation unit.

5. The system according to claim 4, wherein the second control unit is configured to, after the focus lens reaches the second focus position based on the operation on the third operation unit and stops moving, perform control to execute the adjustment processing based on the operation on the second operation unit regardless of whether the predetermined setting is the first setting or the second setting.

6. The system according to claim 4, wherein the second control unit is configured to, in a case where the predetermined setting is a third setting, perform control so as not to execute the adjustment processing based on the operation on the second operation unit when either a first condition or a second condition is satisfied, and perform control to execute the adjustment processing based on the operation on the second operation when neither the first condition nor the second condition is satisfied, the first condition being that the focus lens be moving due to the execution of the second function based on the operation on the third operation unit, the second condition being that the operation on the third operation unit continue.

7. The system according to claim 1, further comprising a communication unit via which the lens apparatus and the camera apparatus communicate,
wherein the second control unit is included in the camera apparatus, and
wherein the second control unit is configured to obtain lens driving state information from the lens apparatus via the communication unit, determine whether to execute the adjustment processing based on the obtained lens driving state information and the predetermined setting, and transmit availability information about whether to execute the adjustment processing to the lens apparatus via the communication unit, the lens driving state information indicating whether the focus lens is moving.

8. The system according to claim 7,
wherein the first control unit is included in the lens apparatus, and
wherein the first control unit is configured to, while the focus lens is moving due to the execution of the first function based on the operation on the first operation unit, perform control so as not to execute the adjustment processing based on the operation on the second operation unit, and while the focus lens is moving due to the execution of the second function based on the operation on the third operation unit, switch whether to execute the adjustment processing based on the operation on the second operation unit, depending on the availability information transmitted from the camera apparatus.

9. The system according to claim 1, wherein the lens apparatus further includes a fourth operation unit assigned the second function.

10. The system according to claim 1,
wherein the second operation unit is a focus ring, and
wherein the lens apparatus includes a focus adjustment unit configured to execute the adjustment processing by moving the focus lens based on an amount of rotation of the focus ring.

11. The system according to claim 1, wherein the predetermined setting is a setting related to whether to capture a still image or a moving image.

12. The system according to claim 1, wherein the predetermined setting is a setting related to a manual focus adjustment operation, the setting being configured via a menu screen.

13. The system according to claim 1,
wherein the lens apparatus includes a first registration unit configured to store a current position of the focus lens into the storage unit of the lens apparatus as the first focus position based on a fifth operation on the lens apparatus, and
wherein the camera apparatus includes a second registration unit configured to store the current position of the focus lens into the storage unit of the camera apparatus as the second focus position based on a sixth operation on the camera apparatus.

14. A method for controlling a system including a lens apparatus and a camera apparatus, the lens apparatus including a focus lens, a first operation unit that is assigned a first function of moving the focus lens to a first focus position stored in advance, and a second operation unit configured to accept an operation for executing adjustment processing to move the focus lens to a focus position based on an amount of operation, the camera apparatus including a third operation unit that is assigned a second function of moving the focus lens to a second focus position stored in advance, the method comprising:
performing, while the focus lens is moving due to execution of the first function based on an operation on the first operation unit, control so as not to execute the adjustment processing based on the operation on the second operation unit; and
performing, while the focus lens is moving due to execution of the second function based on an operation on the third operation unit, control to switch execution and non-execution of the adjustment processing based on the operation on the second operation unit, depending on a predetermined setting of the camera apparatus.

15. A camera configured to communicate with a lens apparatus including a focus lens, a first operation unit that is assigned a first function of moving the focus lens to a first focus position stored in a storage unit of the lens apparatus in advance, a second operation unit different from the first operation unit, the second operation unit being configured to accept an operation for executing adjustment processing to move the focus lens to a focus position based on an amount of operation, and a first control unit configured to perform, while the focus lens is moving due to execution of the first function based on an operation on the first operation unit, control so as not to execute the adjustment processing based on the operation on the second operation unit, the camera comprising:
a third operation unit that is assigned a second function of moving the focus lens to a second focus position stored in a storage unit of the camera in advance; and
a second control unit configured to, while the focus lens is moving due to execution of the second function based on an operation on the third operation unit, perform control to switch execution and non-execution of the adjustment processing based on the operation on the second operation unit, depending on a predetermined setting of the camera.

16. A camera configured to communicate with a lens apparatus including a focus lens, a first operation unit that is assigned a first function of moving the focus lens to a first focus position stored in a storage unit of the lens apparatus in advance, and a second operation unit, the second operation unit being configured to accept an operation for executing adjustment processing to move the focus lens to a focus position based on an amount of operation, the camera comprising:
a third operation unit that is assigned a second function of moving the focus lens to a second focus position stored in a storage unit of the camera in advance;
a first control unit configured to, while the focus lens is moving due to execution of the first function based on an operation on the first operation unit, perform control so as not to execute the adjustment processing based on the operation on the second operation unit; and
a second control unit configured to, while the focus lens is moving due to execution of the second function based on an operation on the third operation unit, perform control to switch execution and non-execution of the adjustment processing based on the operation on the second operation unit, depending on a predetermined setting of the camera.

17. A non-transitory computer-readable storage medium storing a program for causing a computer to function as each unit of the camera according to claim 15.

18. A non-transitory computer-readable storage medium storing a program for causing a computer to function as each unit of the camera according to claim 16.
